(19) United States
(12) Patent Application Publication
(10) Pub. No.: US 2025/0189353 A1
(43) Pub. Date: Jun. 12, 2025

(54) MEASURING TUBE SYSTEM, MEASURING TUBE AND PRODUCTION METHOD FOR A MEASURING TUBE SYSTEM

(71) Applicant: Endress+Hauser Flowtec AG, Reinach (CH)

(72) Inventors: Dieter Mundschin, Liestal (CH); Benjamin Schwenter, Ettingen (CH)

(21) Appl. No.: 18/710,739

(22) PCT Filed: Nov. 8, 2022
(86) PCT No.: PCT/EP2022/081054

§ 371 Date: May 16, 2024

(30) Foreign Application Priority Data
Nov. 17, 2021 (DE) 10 2021 130 048.7

(51) Int. Cl. G01F 1/84; G01F 15/18; G01N 9/24; G01N 11/00; G01N 11/04

(52) U.S. Cl. CPC G01F 1/8409; G01F 15/185; G01N 9/24; G01N 11/04; G01N 2011/0073

(57) ABSTRACT

A measuring tube system for a measuring device comprises at least one measuring tube for conducting a flowable medium, wherein the measuring tubes each have two end regions, a first block with at least one first channel passing through the first block, wherein the measuring tubes, in a first end region, are each at least partially conducted through the corresponding first channels and are fixed in the corresponding first channels, a second block with at least one of second channel passing through the second block, wherein the first block and the second block are arranged such that the first channels and the second channels correspondingly adjoin one another and the first block and the second block are connected in a fluid-tight manner. Also disclosed is a measuring device comprising the measuring tube system, and a production method for the measuring tube system.

The invention relates to a measuring transducer of a measuring device for detecting a mass flow rate, a viscosity, a density, and/or a variable derived therefrom, of a flowable medium, as well as a corresponding measuring device.

In process and automation technology, so-called in-line measuring devices are often used to measure physical parameters of media flowing in pipelines, such as mass flow rate, density, and/or viscosity, through the measuring transducer of which measuring devices the vibration type of the medium flows. The basic design of such a measuring device, in particular a measuring device designed as a Coriolis flow meter, is described, for example, in EP 1 807 681 A1.

Typically, Coriolis flow meters have at least one or more vibratable measuring tubes which can be set into vibration by means of a vibration exciter. These vibrations are transmitted along the tube length and are varied by the type of flowable medium located in the measuring tube and by its flow rate. At another point in the measuring tube, a vibration sensor or, in particular, two vibration sensors arranged at a distance from one another can record at least one deflection of the vibrations in the form of a measurement signal or a plurality of measurement signals. An evaluation unit can then determine the flow rate, the viscosity, and/or the density of the medium from the measurement signal(s).

A Coriolis flow meter often has not just one curved measuring tube, but two, four or eight measuring tubes, which run parallel to each other at least in pairs. A higher number of measuring tubes is generally used for larger pipeline diameters and high mass flow rates, so that the free-flowing medium is divided between a plurality of measuring tubes so as not to increase the size of the measuring tubes exorbitantly. Such measuring devices are known, for example, from WO 2012/150241 A2 and U.S. Pat. No. 4,891,991 A1.

As a rule, such measuring tube arrangements are formed by a defined number of separate measuring tubes, which are then welded together, for example, in the region of an inlet and outlet of the measuring device.

However, weld-free connections are desired. Currently, the welded joints sometimes have to undergo extensive testing for approval and safety purposes, for example using an X-ray process. The welded joints are also critical, in particular for high pressure applications (in the range of over 100 bar), as the weld seams on the measuring tubes in particular are generally unable to withstand high pressures.

The object of the present invention is therefore to provide a measuring tube arrangement and a measuring device which can also be used at high pressures, in particular at pressures above 100 bar, and which are designed to be weld-free.

The object is achieved by a measuring tube system for a measuring device, comprising:
an n-fold number of measuring tubes for conducting the flowable medium, wherein the measuring tubes each have two end regions, and wherein n>=1,
a first block with the n-fold number of first channels passing through the first block, wherein the measuring tubes, in a first end region, are each at least partially conducted through the corresponding first channels and are integrally, frictionally or form-fittingly fixed in the corresponding first channels,
a second block with the n-fold number of second channels passing through the second block, wherein the first block and the second block are arranged in such a way that the first channels and the second channels correspondingly adjoin one another and the first block and the second block are connected in a fluid-tight, but leak-free, manner.

The measuring tube system according to the invention thus consists of at least one measuring tube, which is connected to a measuring block system consisting of two blocks. The measuring tube, or the plurality of measuring tubes, is conducted into a channel of the first block and firmly connected thereto. The second block, which has a corresponding channel on a first side and on a second side, in particular the process connector, while these sides are connected to corresponding channels, is connected to the first block in a fluid-tight (in the sense of leak-free) manner, so that the fluid to be examined can flow through the corresponding channels of the blocks without being able to escape at the transition region of the first block and the second block.

The measuring tube system according to the invention has no welded joints and can also be used reliably in applications where high pressures (>100 bar) prevail.

According to an advantageous embodiment, it is provided that the measuring tubes, in the end region, each have a conical flange, wherein the second channels each have a conical taper. The flange is created by flanging the measuring tube in the first end region. Flanging means bending the edge of the measuring tube (once or several times).

According to an advantageous embodiment, it is provided that the measuring sensor has the n-fold number of sealing elements, wherein the sealing elements each have a first conical end region and a second conical end region, wherein the sealing elements are each inserted between the first block and the second block in such a way that the first conical end region of a sealing element terminates with the conical flanging of the end region of the corresponding measuring tube and that the second conical end region of the sealing element terminates with the conical taper of the corresponding second channel. One sealing element, for example a sleeve, is therefore provided for each measuring tube. The sealing element is used to connect the first and second blocks in a fluid-tight and leak-free manner. It is provided that the particular cone, in the first end region and in the second end region of the sealing element, is designed in such a way that it corresponds in each case to the cone of the flange and of the second channel, i.e., in particular has the same angle and the same diameter. As a result, the sealing element is in contact with a large area of the flange and the particular second channel.

In this case, it is provided that the sealing element has a third channel, which third channel connects the first channel to the second channel after insertion of the sealing element.

According to an advantageous embodiment, it is provided that the measuring tube system comprises a connection element, in particular a union nut, which connection element is designed to connect the first block to the second block and to form a pressing force between the first block and the second block. The pressing force therefore presses the sealing element against the flanging and the second channel of the second block and creates the fluid-tight and leak-free connection between the first and second blocks.

It is provided that the connection element is attached to corresponding receptacles of the first block and the second block. The corresponding receptacles are in particular threads. The connection element is a union nut, for example. By tightening the connection element, the second block presses on the first block, wherein the pressing force is produced and the conical elements produce the seal.

According to an advantageous embodiment, it is provided that the measuring tubes are fixed in the corresponding first channels by means of a solder joint. Alternatively, the measuring tubes can also be fixed in the corresponding first channels by means of an adhesive connection or mechanically (e.g., by hooking), in particular if the application is not in the high-pressure range.

According to an advantageous embodiment, it is provided that in the case that n>=2, the second channels converge in the second block and leave the second block in a common channel. The second block is used as a distribution block. A second channel is provided for each measuring tube, which second channel opens into the common channel. In particular, the second block is provided with a process connector into which the common channel opens. The fluid thus passes into the respective measuring tube from the process connector, or vice versa, via the second channel, the third channel and the first channel without leaking.

A measuring tube system according to one of the preceding claims, wherein the first block, or a third block, has an n-fold number of further first channels, wherein the measuring tubes, in the other end region, are each at least partially conducted through the corresponding first channels and are integrally, frictionally or form-fittingly fixed in the corresponding further first channels, wherein a fourth block is provided with the n-fold number of further second channels passing through the second block, wherein the first block, or the third block, and the fourth block are arranged in such a way that the further first channels and the further second channels correspondingly adjoin one another and the first block, or the third block, and the fourth block are connected in a fluid-tight, but leak-free, manner. The inlet and outlet are thus formed, so that the measuring tube system can be completely connected to the process. The first and second blocks can each be continuous or consist of a plurality of individual blocks (one for the inlet, one for the outlet).

A measuring tube system according to at least one of the preceding claims, wherein n is equal to 1, wherein n is equal to 2, or wherein n is equal to 4. In practice, the measuring tube system is typically designed symmetrically, i.e., with a number of measuring tubes that is a multiple of 2. Theoretically, however, any number of measuring tubes (even n greater than 4) can be used.

Furthermore, the object is achieved by a method for producing a measuring tube system, comprising:
providing an n-fold number of measuring tubes, the n-fold number of sealing elements, a first block with the n-fold number of first channels passing through the first block, a second block with the n-fold number of second channels passing through the second block, and a connection element, wherein the measuring tubes each have two end regions for conducting a flowable medium, and wherein the sealing elements each have a first conical end region and a second conical end region, and wherein n>=1;
integrally, frictionally or form-fittingly connecting an end region of the measuring tubes to the corresponding first channels;
flanging the end regions of the measuring tubes to form a conical flange;
inserting the sealing elements between the first block and the second block in such a way that the first conical end region of a sealing element terminates with the conical flanging of the end region of the corresponding measuring tube and that the second conical end region of the sealing element terminates with the conical taper of the corresponding second channel;
attaching the connection element to corresponding receptacles of the first block and the second block; and
forming a pressing force between the first block and the second block by tightening the connection element.

The object is also achieved by a measuring device for detecting a mass flow rate, a viscosity, a density, and/or a variable derived therefrom, of a flowable medium, comprising:
a measuring tube system according to at least one of the preceding claims,
at least one vibration exciter which is designed to excite the at least one measurement tube to vibrate,
at least one vibration sensor which is designed to detect at least one deflection of a vibration of the measuring tube,
an electronic measuring and/or operating circuit, wherein the electronic measuring and/or operating circuit is designed to operate the at least one vibration sensor and the at least one vibration exciter and is connected thereto by means of electrical connections, wherein the electronic measuring and/or operating circuit is designed to ascertain and provide the mass flow rate, the viscosity, and/or the density, and/or the variable derived therefrom, of a flowable medium.

In particular, the measuring device according to the invention is a Coriolis measuring device. Said Coriolis measuring device is characterized by its suitability for use at high pressures of over 100 bar of the flowable medium, whereby the required tightness is achieved by the pressure of the first block on the second block.

The present invention is explained in greater detail with reference to the following figures. In the figures:

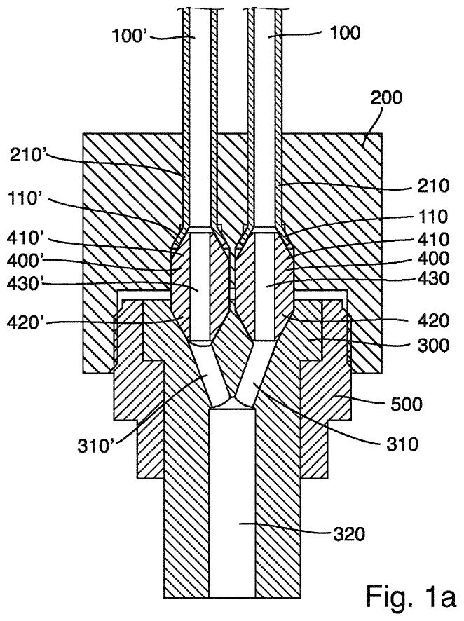

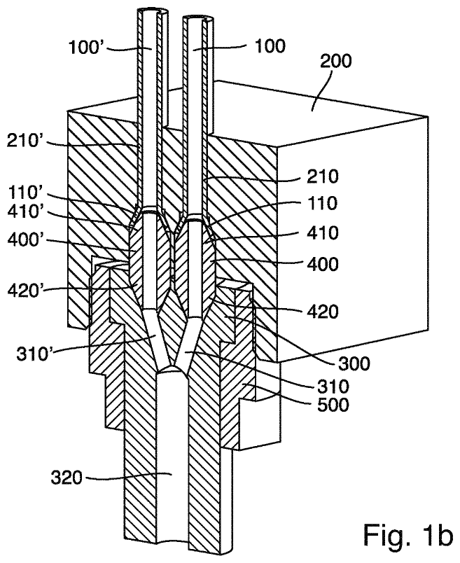

FIG. 1 shows an embodiment of the measuring tube system according to the invention, and

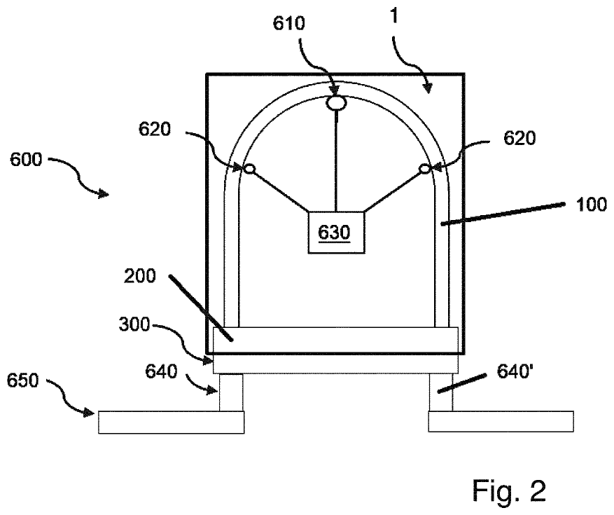

FIG. 2 shows an embodiment of the measuring device according to the invention.

FIG. 1 shows a cross section through an exemplary embodiment of the measuring tube system 1 according to the invention. FIG. 1a is a frontal view of the cross section, FIG. 1b shows the cross section from an isometric perspective. This example refers to a double-tube system which has two measuring tubes 100, 100′. However, the measuring tube system 1 can also have just one measuring tube or a plurality of measuring tubes.

The measuring tubes 100, 100′ are conducted into a first block 200. For each of the measuring tubes 100, 100′, the first block has a corresponding first channel 210, 210′. The measuring tubes 100, 100′ are integrally, frictionally or form-fittingly connected, in particular soldered, to the channels. The end region of the measuring tubes 100, 100′ is machined in such a way that a conically flared flange 110, 110′ is created in each case.

A second block 300 is also provided. Said second block also has two channels, hereinafter referred to as second channels 310, 310′, which open into a common channel 320. In particular, the common channel 320 opens into a process connector 640. The second block 300 thus acts as a flow divider. The end region of the second channels 310, 310′ facing away from the common channel 320 is conically flared. In particular, the parameters (length, flare angle, start and end diameter) of the particular cone correspond to those of the cone of the flange 110, 110′.

Furthermore, a sealing element 400, 400′ is provided for each of the measuring tubes 100, 100′. Such a sealing element in each case has a first end region 410, 410′ and a second end region 420, 420′, as well as a third channel 330, 330′ between these end regions 410, 420, 410′, 420′. The first and second end regions 410, 420, 410′, 420′ are each conically tapered in such a way that the first end region 410, 410′ fits into the corresponding flanging 110, 110′ of a measuring tube 100, 100′ and that the second end region 420, 420′ fits into the corresponding end region of a second channel 310, 310′ of the second block 300, in particular approximately exactly. In particular, the parameters (length, flare angle, start and end diameters) of the particular cone of the first end region correspond to the parameters (length, taper angle, start and end diameters) of the cone of the flange 110, 110′, or correspondingly the parameters (length, flare angle, start and end diameters) of the particular cone of the first end region correspond to the parameters (length, taper angle, start and end diameters) of the particular end region of a second channel 310, 310′ of the second block 300.

In each case, a sealing element 400, 400′ is inserted between the first block 200 and the second block 300, more precisely between the flange 110, 110′ and the end region of a second channel 310, 310′. The second block 300 is in particular cylindrical in shape, with an increase in diameter in the direction of the end region of the second channels 310, 310′. A connection element 500, in particular a union nut having an external thread, is placed thereover. The first block 200, which has a corresponding depression for (partially) receiving the cylindrical second block 300, has corresponding internal threads in the receptacle. By tightening the connection element 500, it generates a force in the axial direction of the measuring tubes 100, 100′ and presses the second block 300 onto the first block 200. The end regions 410, 410′, 420, 420′ of the sealing elements 400, 400′ are now pressed onto the flanges 110, 110′ and onto the end regions of the second channels 310, 310′, thereby creating a fluid-tight and leakage-free connection. Fluid can thus flow from the process connector 640 into the measuring tubes 100, 100′ and vice versa.

The materials chosen for the first and second blocks 200, 300, as well as the sealing elements 400, 400′ and the connection element 500, are metal or ceramic materials which have sufficient strength to withstand the pressing force.

For the other end region of the measuring tubes 100, 100′, a similar attachment as described above is provided. A first and second block 200, 300 that is continuous up to the end position of the other end region of the measuring tubes 100, 100′ can be used, or a separate third and fourth block, wherein the blocks are connected with sealing elements according to the invention and which blocks and sealing elements have corresponding first, second, third and common channels as described above.

FIG. 2 shows a schematic drawing of a measuring device 600 according to the invention. The measuring tube system 1 is connected to a pipeline 650, which carries the flowable medium, via a process connector 640, 640′ attached to the inlet and outlet.

A vibration exciter 610 is mounted in a curved region of the measuring tubes 100, 100′, which vibration exciter excites the measuring tubes 100, 100′ to vibrate. At least one deflection of a vibration of the measuring tubes 100, 100′ is detected via at least one, in this example two, vibration sensors 620. Both the vibration exciter 610 and the vibration sensors 620 are connected to and operated by an electronic measuring and/or operating circuit 630 arranged within the measuring device 600. Based on the at least one deflection of a vibration of the measuring tubes 100, 100′, the electronic measuring and/or operating circuit 630 determines the mass flow rate, the viscosity, and/or the density, and/or the variable derived therefrom, of a flowable medium and makes these available.

### LIST OF REFERENCE SIGNS

1 Measuring tube system
100, 100′ Measuring tube
110, 110′ Conical flange
200 First block
210, 210′ First Channels
300 Second block
310, 310′ Second channels
320 Common channel
400, 400′ Sealing element
410, 410′ First conical end region
420, 420′ Second conical end region
430 Third channel
500 Connection element
600 Measuring device
610 Vibration exciter
620 Vibration sensor
630 Electronic measuring and/or operating circuit
640, 640′ Process connector
650 Pipeline

1-14. (canceled)

15. A measuring tube system for a measuring device, comprising:
an n-fold number of measuring tubes for conducting a flowable medium, wherein the measuring tubes each have two end regions, and wherein n>=1;
a first block with an n-fold number of first channels passing through the first block, wherein the measuring tubes, in a first end region, are each at least partially conducted through the corresponding first channels and are integrally, frictionally, and/or form-fittingly fixed in the corresponding first channels; and
a second block with an n-fold number of second channels passing through the second block, wherein the first block and the second block are arranged such that the first channels and the second channels correspondingly adjoin one another and the first block and the second block are connected in a fluid-tight manner.

16. The measuring tube system according to claim 15, wherein each of the measuring tubes, in the first end region, has a conical flange, wherein each of the second channels has a conical taper.

17. The measuring tube system according to claim 16, further comprising:
an n-fold number of sealing elements,
wherein each of the sealing elements has a first conical end region and a second conical end region,
wherein the sealing elements are each inserted between the first block and the second block such that the first conical end region of the sealing elements terminates with the conical flange of the first end region of the corresponding measuring tube and that the second conical end region of the sealing element terminates with the conical taper of the corresponding second channel.

18. The measuring tube system according to claim 17, wherein the sealing element has a third channel, that connects the corresponding first channel to the corresponding second channel after insertion of the sealing element.

19. The measuring tube system according to claim 15, further comprising:
a connection element designed to connect the first block to the second block and to form a pressing force between the first block and the second block.

20. The measuring tube system according to claim 19, wherein the connection element is attached to corresponding receptacles of the first block and the second block.

21. The measuring tube system according to claim 20, wherein the corresponding receptacles are threads.

22. The measuring tube system according to claim 15, wherein the measuring tubes are fixed in the corresponding first channels by a solder joint.

23. The measuring tube system according to claim 15, wherein when n>=2, the second channels converge in the second block and leave the second block in a common channel.

24. The measuring tube system according to claim 23, wherein the second block includes a process connector into which the common channel opens.

25. The measuring tube system according to claim 15,
wherein the first block, or a third block, has an n-fold number of further first channels, wherein the measuring tubes, in a second end region, are each at least partially conducted through the corresponding first further channels and are integrally, frictionally, and/or form-fittingly fixed in the corresponding further first channels, wherein a fourth block is provided with the n-fold number of further second channels passing through the fourth block, wherein the first block, or the third block, and the fourth block are arranged in such a way that the further first channels and the further second channels correspondingly adjoin one another and the first block, or the third block, and the fourth block are connected in a fluid-tight manner.

26. The measuring tube system according to claim 15, wherein n is equal to 1.

27. A method for producing a measuring tube system, comprising:
providing an n-fold number of measuring tubes, an n-fold number of sealing elements, a first block with an n-fold number of first channels passing through the first block, a second block with the n-fold number of second channels passing through the second block, and a connection element, wherein the measuring tubes each have two end regions for conducting a flowable medium, and wherein the sealing elements each have a first conical end region and a second conical end region, and wherein n>=1;
integrally, frictionally, or form-fittingly connecting a first end region of the measuring tubes to the corresponding first channels;
flanging the first end regions of the measuring tubes to form a conical flange;
inserting the sealing elements between the first block and the second block such that the first conical end region of the sealing element terminates with the conical flange of the first end region of the corresponding measuring tube and that the second conical end region of the sealing element terminates with the conical taper of the corresponding second channel;
attaching the connection element to corresponding receptacles of the first block and the second block; and
forming a pressing force between the first block and the second block by tightening the connection element.

28. A measuring device for detecting a mass flow rate, a viscosity, a density, and/or a variable derived therefrom, of a flowable medium, comprising:
a measuring tube system, including:
an n-fold number of measuring tubes for conducting a flowable medium, wherein the measuring tubes each have two end regions, and wherein n>=1;
a first block with an n-fold number of first channels passing through the first block, wherein the measuring tubes, in a first end region, are each at least partially conducted through the corresponding first channels and are integrally, frictionally, and/or form-fittingly fixed in the corresponding first channels; and
a second block with an n-fold number of second channels passing through the second block, wherein the first block and the second block are arranged such that the first channels and the second channels correspondingly adjoin one another and the first block and the second block are connected in a fluid-tight manner;
at least one vibration exciter which is designed to excite the measuring tubes to vibrate;
at least one vibration sensor which is designed to detect at least one deflection of a vibration of the measuring tubes; and
an electronic measuring and/or operating circuit designed to operate the at least one vibration sensor and the at least one vibration exciter and is connected thereto by means of electrical connections, wherein the electronic measuring and/or operating circuit is further designed to ascertain and provide the mass flow rate, the viscosity, and/or the density, and/or the variable derived therefrom, of a flowable medium.
